(19) United States
(12) Patent Application Publication
(10) Pub. No.: US 2024/0411993 A1
(43) Pub. Date: Dec. 12, 2024

(54) VERIFICATION APPARATUS, VERIFICATION METHOD, AND STORAGE MEDIUM

(71) Applicant: NEC Corporation, Minato-ku, Tokyo (JP)

(72) Inventor: Masafumi OYAMADA, Tokyo (JP)

(73) Assignee: NEC Corporation, Minato-ku, Tokyo (JP)

(21) Appl. No.: 18/709,852

(22) PCT Filed: Mar. 2, 2022
(86) PCT No.: PCT/JP2022/008756

§ 371 Date: May 14, 2024

(51) Int. Cl. G06F 40/289

(52) U.S. Cl. CPC G06F 40/289

(57) ABSTRACT

In order to make it possible to automatically carry out verification of a hypothetical sentence, a verification apparatus (1) includes: a hypothetical sentence acquisition section (11) for acquiring a hypothetical sentence which is to be verified; and a verification section (12) for determining truth or falsity of the hypothetical sentence based on a degree to which the hypothetical sentence is entailed in a premise sentence that has been generated from a finding derived from verification data for use in verification of a hypothesis.

### TECHNICAL FIELD

The present disclosure relates to a verification apparatus, and the like for carrying out verification of a hypothesis.

### BACKGROUND ART

Hypothesis verification based on data is important. For example, it is assumed that an employee at a store feels that “products of genre A sell well on rainy days”. However, this is only a feeling of the employee, and it is not known whether or not “products of genre A sell well on rainy days”. In this example, no data-based verification has been conducted for the hypothesis that “products of genre A sell well on rainy days”. Therefore, there is no rational reason to carry out an action (e.g., an action such as increasing purchase of products of genre A on rainy days) based on this hypothesis.

In general, verification of a hypothesis is carried out by designing a data analysis task for confirming correctness of the hypothesis and carrying out the data analysis task. For example, in the above example, if product sales data for each weather is collected, it is possible to confirm, based on the collected data, whether or not the hypothesis that “products of genre A sell well on rainy days” is correct.

### CITATION LIST

### Patent Literature

[Patent Literature 1]
Japanese Patent Application Publication, Tokukai, No. 2019-117556

### SUMMARY OF INVENTION

### Technical Problem

However, such a conventional verification method as described above has a problem that it takes a lot of manpower and time. Therefore, there has been a demand for a technique for automatically carrying out verification of a hypothesis, in particular, a hypothetical sentence expressed in text as in the above-described example. However, there has been no such technique.

Examples of a technique related to generation of a hypothesis include Patent Literature 1 above. Patent Literature 1 discloses a technique, in recognition processing using a local recognizer and a global recognizer, to verify whether or not a hypothesis that a recognition result by at least one of the recognition means includes an error is adequate. However, this technique can verify only a hypothesis that a recognition result by at least one of the recognition means includes an error, and it is not possible to carry out verification of a hypothetical sentence expressed in text.

An example aspect of the present invention is accomplished in view of the above problem, and an example object thereof is to provide a verification apparatus and the like that are capable of automatically carrying out verification of a hypothetical sentence.

### Solution to Problem

A verification apparatus in accordance with an example aspect of the present invention includes: a hypothetical sentence acquisition means for acquiring a hypothetical sentence which is to be verified; and a verification means for determining truth or falsity of the hypothetical sentence based on a degree to which the hypothetical sentence is entailed in a premise sentence that has been generated from a finding derived from verification data for use in verification of a hypothesis.

A verification method in accordance with an example aspect of the present invention includes: acquiring, by at least one processor, a hypothetical sentence which is to be verified; and determining, by the at least one processor, truth or falsity of the hypothetical sentence based on a degree to which the hypothetical sentence is entailed in a premise sentence that has been generated from a finding derived from verification data for use in verification of a hypothesis.

A verification program in accordance with an example aspect of the present invention causes a computer to function as: a hypothetical sentence acquisition means for acquiring a hypothetical sentence which is to be verified; and a verification means for determining truth or falsity of the hypothetical sentence based on a degree to which the hypothetical sentence is entailed in a premise sentence that has been generated from a finding derived from verification data for use in verification of a hypothesis.

### Advantageous Effects of Invention

According to an example aspect of the present to automatically carry out invention, it is possible verification of a hypothetical sentence.

### BRIEF DESCRIPTION OF DRAWINGS

FIG. 1 is a block diagram illustrating a configuration of a verification apparatus in accordance with a first example embodiment of the present invention.

FIG. 2 is a flowchart illustrating a flow of a verification method in accordance with the first example embodiment of the present invention.

FIG. 3 is a diagram illustrating an overview of a verification method in accordance with a second example embodiment of the present invention.

FIG. 4 is a block diagram illustrating a configuration of a verification apparatus in accordance with the second example embodiment of the present invention.

FIG. 5 is a diagram illustrating an example from derivation of an insight to generation of a premise sentence in the second example embodiment of the present invention.

FIG. 6 is a diagram illustrating another example from derivation of an insight to generation of a premise sentence in the second example embodiment of the present invention.

FIG. 7 is a flowchart illustrating a flow of a process carried out by the verification apparatus in accordance with the second example embodiment of the present invention.

FIG. 8 is a diagram illustrating an example of a computer which executes instructions of a program that is software realizing functions of the apparatus according to each of example embodiments of the present invention.

### EXAMPLE EMBODIMENTS

### First Example Embodiment

The following description will discuss a first example embodiment of the present invention in detail, with reference to the drawings. The present example embodiment is a basic form of example embodiments described later.

### (Configuration of Verification Apparatus)

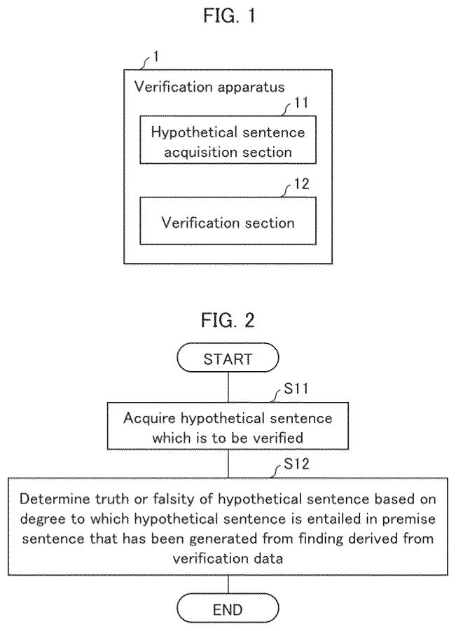

The following description will discuss a configuration of a verification apparatus 1 in accordance with the present example embodiment, with reference to FIG. 1. FIG. 1 is a block diagram illustrating the configuration of the verification apparatus 1. As illustrated in FIG. 1, the verification apparatus 1 includes a hypothetical sentence acquisition section 11 (hypothetical sentence acquisition means) and a verification section 12 (verification means).

The hypothetical sentence acquisition section 11 acquires a hypothetical sentence which is to be verified. The verification section 12 determines truth or falsity of a hypothetical sentence based on a degree to which the hypothetical sentence is entailed in a premise sentence that has been generated from a finding derived from verification data for use in verification of a hypothesis.

As described above, the verification apparatus 1 in accordance with the present example embodiment employs the configuration of including: the hypothetical sentence acquisition section 11 for acquiring a hypothetical sentence which is to be verified; and a verification section 12 for determining truth or falsity of the hypothetical sentence based on a degree to which the hypothetical sentence is entailed in a premise sentence that has been generated from a finding derived from verification data for use in verification of a hypothesis. According to this configuration, it is possible to automatically carry out verification of a hypothetical sentence.

### (Verification Program)

The functions of the verification apparatus 1 described above can also be realized by a program. A verification program in accordance with the present example embodiment causes a computer to function as: a hypothetical sentence acquisition means for acquiring a hypothetical sentence which is to be verified; and a verification means for determining truth or falsity of the hypothetical sentence based on a degree to which the hypothetical sentence is entailed in a premise sentence that has been generated from a finding derived from verification data for use in verification of a hypothesis. According to this verification program, it is possible to automatically carry out verification of a hypothetical sentence.

### (Flow of Verification Method)

The following description will discuss a flow of a verification method in accordance with the present example embodiment, with reference to FIG. 2. FIG. 2 is a flowchart illustrating the flow of the verification method. Note that an execution subject of each of steps in the verification method may be a processor that is included in the verification apparatus 1. The execution subject may be a processor that is included in another apparatus. Alternatively, execution subjects of respective steps may be processors provided in different apparatuses.

In S11, at least one processor acquires a hypothetical sentence which is to be verified.

In S12, the at least one processor determines truth or falsity of a hypothetical sentence based on a degree to which the hypothetical sentence is entailed in a premise sentence that has been generated from a finding derived from verification data for use in verification of a hypothesis.

As described above, the verification method in accordance with the present example embodiment includes: acquiring, by at least one processor, a hypothetical sentence which is to be verified (S11); and determining, by the at least one processor, truth or falsity of the hypothetical sentence based on a degree to which the hypothetical sentence is entailed in a premise sentence that has been generated from a finding derived from verification data for use in verification of a hypothesis (S12). According to this verification method, it is possible to automatically carry out verification of a hypothetical sentence.

### Second Example Embodiment

The following description will discuss a second example embodiment of the present invention in detail, with reference to the drawings.

### Overview of Verification Method

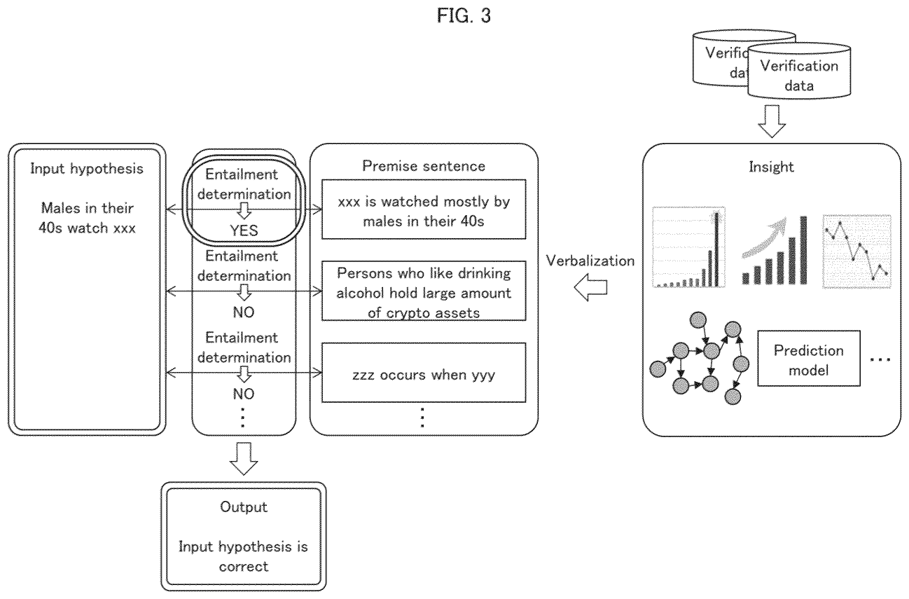

FIG. 3 is a diagram illustrating an overview of a verification method (hereinafter referred to as a present method) in accordance with the present example embodiment. The present method carries out verification of an input hypothetical sentence (hereinafter also referred to as an input hypothesis). In the example of FIG. 3, the text “males in their 40s watch xxx” is an input hypothesis, and whether or not this input hypothesis is correct is determined based on verification data. The input hypothesis may be any hypothesis whose correctness can be determined. The input hypothesis may be a hypothesis that can be determined as to which one of correct, incorrect, and neither correct nor incorrect falls under the hypothesis.

The verification data only needs to be data that can derive an insight (described later), and a form (modality) thereof is not particularly limited. For example, the verification data may be structured data such as a data table, may be semi-structured data (such as data in JavaScript object notation (JSON) format or extensible markup language (XML) format), or may be unstructured data (such as text data, image data, and audio data). The verification data may be acquired, for example, from a data lake in which various kinds of data in various formats are contained.

In the present method, an insight is first derived from verification data, rather than using verification data as it is. The insight is a finding which is meaningful for humans. Therefore, the “insight” in the following description can be replaced with a “finding”. Alternatively, the insight can be said to be data pertaining to foresight that is apparent from data pertaining to consumers in consumer surveys, statistical surveys, and the like, data pertaining to subjects of statistics, and the like. Examples of the insight includes visualized verification data such as various graphs (bar graph, line graph) as illustrated in FIG. 3.

Other examples of the insight include a causal graph, a prediction model, and the like which are generated using verification data. Note that the causal graph refers to data having a structure composed of a plurality of nodes and links connecting the nodes. In the causal graph, a relationship such as a causal relationship between nodes is expressed by links.

In the present method, for example, it is also possible to utilize, as an insight, a result obtained by analyzing verification data by various analysis methods. For example, in a case where the verification data indicates a purchase history of a product, it is possible to use, as an insight, information which has been specified by basket analysis of the verification data and which indicates a combination of products that are purchased together. Details of a method for deriving an insight will be described later.

Next, in the present method, the insight derived as described above is verbalized. In other words, the present method generates, from the insight, text related to the insight. In the present method, the text thus generated is used as a premise sentence for use in verification of an input hypothesis. For example, in the example of FIG. 3, premise sentences such as “xxx is watched mostly by males in their 40s”, “persons who like drinking alcohol hold a large amount of crypto assets”, and “zzz occurs when yyy” are generated. Details of a method for generating a premise sentence will be described later.

The process from derivation of an insight to generation of a premise sentence does not necessarily need to be carried out at the time of verification of a hypothesis, and only needs to be carried out before carrying out the verification of a hypothesis. By deriving various insights from various pieces of verification data and generating premise sentences from those insights, it is possible to enhance accuracy of verification of a hypothesis.

In the present method, truth or falsity of an input hypothesis is determined based on a degree to which the premise sentence generated as described above entails the input hypothesis. In a case where a premise sentence entails a hypothetical sentence, such a case means that the premise sentence and the hypothetical sentence contain the same content. In addition, in a case where a premise sentence generated based on verification data contains the same content as an input hypothesis, it can be said that the verification data supports correctness of the input hypothesis. Therefore, it is possible to determine truth or falsity of the input hypothesis based on a degree to which the premise sentence generated based on the verification data entails the input hypothesis.

In the example of FIG. 3, it has been determined that the premise sentence “xxx is watched mostly by males in their 40s” entails an input hypothesis, and a verification result that the input hypothesis is correct is output based on the determination result. Thus, according to the present method, it is possible to automatically carry out verification of an input hypothesis.

According to the present method, it is also possible to confirm whether or not a tendency (e.g., the hypothesis exemplified in “Background Art”) felt by a person in charge of a site is correct on the basis of verification data. According to the present method, it is also possible to verify an inference result obtained by artificial intelligence (AI). In this case, the inference result by AI may be expressed in text as a hypothetical sentence. Thus, it is possible to verify validity of the inference result of the AI using verification data which is not related to training data used to train the AI.

### (Configuration of Verification Apparatus)

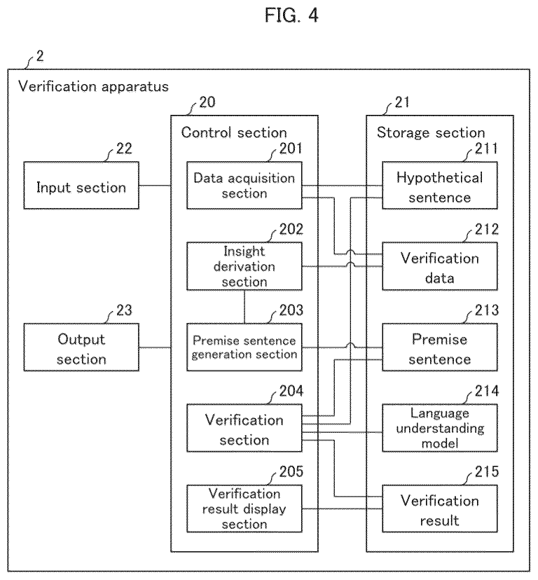

The following description will discuss a configuration of a verification apparatus 2 in accordance with the present example embodiment, with reference to FIG. 4. FIG. 4 is a block diagram illustrating the configuration of the verification apparatus 2. The verification apparatus 2 is an apparatus that carries out verification of a hypothetical sentence. As illustrated in FIG. 4, the verification apparatus 2 includes: a control section 20 that comprehensively controls constituent elements of the verification apparatus 2; and a storage section 21 which is a storage apparatus for storing various kinds of data used by the verification apparatus 2. The verification apparatus 2 further includes: an input section 22 that receives an input operation by a user with respect to the verification apparatus 2; and an output section 23 through which the verification apparatus 2 outputs data. Note that the verification apparatus 2 may be an apparatus only for verification of a hypothetical sentence, or may be a general-purpose apparatus which can be used in the other applications.

The control section 20 includes a data acquisition section 201 (hypothetical sentence acquisition means, verification data acquisition means), an insight derivation section (finding derivation means) 202, a premise sentence generation section (premise sentence generation means) 203, a verification section (verification means) 204, and a verification result display section 205. The storage section 21 stores a hypothetical sentence 211, verification data 212, a premise sentence 213, a language understanding model 214, and a verification result 215.

The data acquisition section 201 acquires a hypothetical sentence which is to be verified, and causes the storage section 21 to store the acquired hypothetical sentence as a hypothetical sentence 211. The data acquisition section 201 also acquires verification data for use in verification of a hypothesis, and causes the storage section 21 to store the acquired verification data as verification data 212. It is of course possible to employ a configuration in which separate processing blocks carry out acquisition of a hypothetical sentence and acquisition of verification data, respectively.

The insight derivation section 202 derives an insight from the verification data 212 acquired by the data acquisition section 201. Then, the premise sentence generation section 203 generates, from the insight derived by the insight derivation section 202, a premise sentence related to the insight, and causes the storage section 21 to store the premise sentence as a premise sentence 213. A method for deriving an insight and a method for generating a premise sentence will be described later.

The verification section 204 determines truth or falsity of a hypothetical sentence to be verified which has been acquired by the data acquisition section 201 based on a degree to which the hypothetical sentence is entailed in the premise sentence 213 generated from the insight derived from the verification data 212. Then, the verification section 204 causes the storage section 21 to store, as a verification result 215, a result of determining truth or falsity of the hypothetical sentence. A method for determining a degree of entailment will be described later.

The verification result display section 205 causes the verification result 215 to be displayed. An apparatus that displays the verification result 215 is not particularly limited. For example, in a case where the output section 23 is a display apparatus, the verification result display section 205 may cause the output section 23 to display the verification result 215. Alternatively, for example, the verification result display section 205 may cause a display apparatus, which is connected to the verification apparatus 2 via a wired connection or wireless connection, to display the verification result 215. An output mode of the verification result 215 may of course be an arbitrary mode, and is not limited to the output by display. Alternatively, it is possible that the verification result 215 is not output and is stored in the storage section 21 or in a storage apparatus which is connected to the verification apparatus 2 via a wired connection or wireless connection.

As described above, the verification apparatus 2 in accordance with the present example embodiment employs the configuration of including: the data acquisition section 201 for acquiring a hypothetical sentence which is to be verified; and the verification section 204 for determining truth or falsity of the hypothetical sentence based on a degree to which the hypothetical sentence to be verified is entailed in a premise sentence that has been generated from an insight derived from the verification data 212 for use in verification of a hypothesis. According to this configuration, it is possible to bring about an example advantage of automatically carrying out verification of a hypothetical sentence.

As described above, the verification apparatus 2 in accordance with the present example embodiment can include: the data acquisition section 201 for acquiring verification data 212; the insight derivation section 202 for deriving an insight from the verification data 212 acquired by the data acquisition section 201; and the premise sentence generation section 203 for generating, from the insight derived by the insight derivation section 202, a premise sentence related to the insight. According to this configuration, it is possible to bring about an example advantage of automatically generating a premise sentence from the verification data 212, in addition to the example advantage brought about by the verification apparatus 1 in accordance with the first example embodiment.

### (Method for Deriving Insight)

The following description will discuss a method for deriving an insight by the insight derivation section 202. As described with reference to FIG. 3, various forms of insights can be applied in the present method. Therefore, various methods for deriving insights can be applied.

For example, a graph can be automatically generated from a table by using a technique called QuickInsights described in the document below. Therefore, for verification data 212 in table form, the insight derivation section 202 may derive a graph, that is, an insight by using QuickInsights.

Rui Ding, Shi Han, Yong Xu, Haidong Zhang, Dongmei Zhang “QuickInsights: Quick and Automatic Discovery of Insights from Multi-Dimensional Data”

Alternatively, the insight derivation section 202 may generate a machine learning model from the verification data 212 using an automated machine learning (AutoML) method. In this case, the machine learning model serves as an insight. Note that, in a case where AutoML is applied and it is necessary to specify an objective variable and an explanatory variable for the machine learning model from among elements included in the verification data 212, the insight derivation section 202 may specify the variables automatically or may cause a user of the verification apparatus 2 to specify the variables. Alternatively, the insight derivation section 202 can derive an insight from the verification data 212 by a method such as AutoBI or AutoCI.

Note that the automated business intelligence (AutoBI) is a technique for enhancing efficiency of sales activities by automatically compiling and visualizing accumulated data such as tabular data. In a case where AutoBI is applied and it is necessary to specify analytical perspectives (e.g., a coordinate axis for deriving a visualization graph) from among elements included in the verification data 212, the perspectives may be automatically specified or may be specified by a user.

The automated customer intelligence (AutoCI) is a technique that automates data analysis related to sales activities such as marketing, sales, and servicing in order to enhance efficiency of customer understanding. In a case where AutoCI is applied and it is necessary to specify parameters (e.g., a customer rank which is decided based on an amount of purchase and indicates whether a customer is a good customer or not) related to customer understanding from among elements included in the verification data 212, the parameters may be automatically specified or may be specified by a user.

The insight derivation section 202 can also derive, as an insight, a causal graph representing a correspondence or a correlation using nodes and links based on verification data 212 representing the correspondence or the correlation.

Alternatively, the insight derivation section 202 may utilize, as an insight, a result obtained by analyzing the verification data 212 by various analysis methods. For example, the insight derivation section 202 may use, as an insight, a prediction expression obtained by regression analysis or multiple regression analysis from verification data 212 in table form. Alternatively, in a case where the verification data 212 indicates a purchase history of a product, the insight derivation section 202 may use, as an insight, information which has been specified by basket analysis of the verification data 212 and which indicates a combination of products that are purchased together.

In a case where the verification data 212 is text, the insight derivation section 202 may generate a summary of the text as an insight. In a case where the verification data 212 is image data, the insight derivation section 202 may determine a subject of the image data and use information indicating the subject as an insight. In a case where the verification data 212 is audio data, the insight derivation section 202 may convert the audio data into text by speech recognition and use the text as an insight. The method for generating a summary from text, the method for determining a subject of image data, and the method for converting audio data into text may be known methods.

As such, various insights can be derived from various forms of verification data 212. Therefore, the data acquisition section 201 may acquire pieces of verification data 212 in a plurality of data formats. In this case, the insight derivation section 202 may derive insights from the respective pieces of verification data 212 in the data formats by applying derivation rules prepared for the respective data formats.

According to this configuration, it is possible to bring about an example advantage of automatically deriving insights from pieces of verification data 212 in a plurality of data formats, in addition to the example advantage brought about by the verification apparatus 1 in accordance with the first example embodiment. Note that the derivation rule may be, for example, a rule base that indicates how to generate an insight from what kind of verification data 212, or may be a machine learning model which has learned, by machine learning, a relationship between verification data 212 and a corresponding insight.

### (Method of Generating Premise Sentence)

The following description will discuss a method for generating a premise sentence by the premise sentence generation section 203. As described above, an insight derived by the insight derivation section 202 can include various forms of insights. Therefore, it is sufficient to prepare a rule for generating a premise sentence corresponding to an insight data format. Accordingly, the premise sentence generation section 203 can generate a premise sentence by applying the generation rule corresponding to the insight data format.

For example, a summary sentence in natural language can be generated from a graph (such as a bar graph or a line graph) by using a technique called Chart-to-Text described in the document below. Therefore, it is possible to apply Chart-to-Text as a generation rule for generating a premise sentence from a graph such as a bar graph or a line graph. Jason Obeid, Enamul Hoque “Chart-to-Text: Generating Natural Language Descriptions for Charts by Adapting the Transformer Model” arXiv: 2010.09142v2 [cs. CL] 29 November.

If a rule for generating a premise sentence for a causal graph is prepared, it is possible to generate a premise sentence from a causal graph when an insight derived by the insight derivation section 202 is the causal graph. For example, a template such as “{node} is in a relation of {link} with {node linked to the node}” may be used as a generation rule for a causal graph. The premise sentence generation section 203 can generate a premise sentence related to a causal graph by inputting, into the template, various kinds of information related to nodes and links indicated in the causal graph.

As such, in a case where the insight derivation section 202 derives insights in a plurality of data formats, the premise sentence generation section 203 may apply generation rules prepared for the respective data formats of insights, and generate premise sentences from the insights of the respective data formats.

According to this configuration, it is possible to bring about an example advantage of automatically generating premise sentences from insights in a plurality of data formats, in addition to the example advantage brought about by the verification apparatus 1 in accordance with the first example embodiment. Note that the generation rule may be, for example, a rule base that indicates how to generate a premise sentence from what kind of insight, or may be a machine learning model which has learned, by machine learning, a relationship between an insight and a corresponding premise sentence. The template described above is an example of a configuration in which a rule base is applied. The above-described Chart-to-Text is an example of a configuration in which a machine learning model is applied.

(Example 1 from Derivation of Insight to Generation of Premise Sentence)

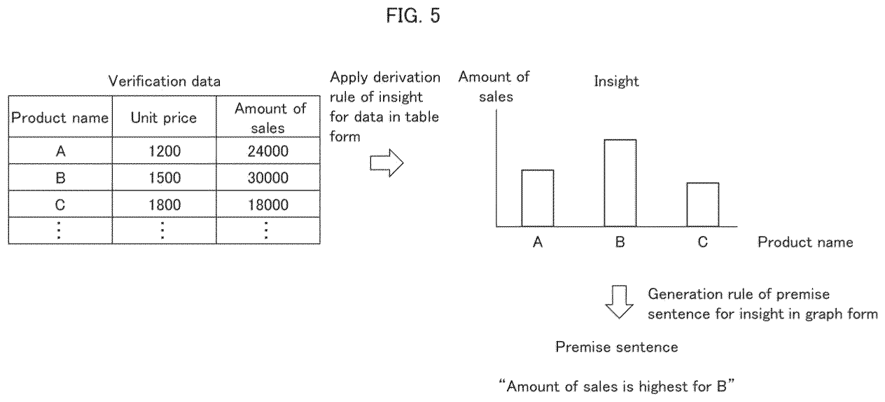

FIG. 5 is a diagram illustrating an example from derivation of an insight to generation of a premise sentence. The verification data 212 illustrated in FIG. 5 is data in table form indicating a relationship between product names, unit prices, and amounts of sales.

In this case, the insight derivation section 202 derives an insight from the verification data 212 by applying a derivation rule of an insight for the verification data 212 in table form. Specifically, in the example of FIG. 5, the insight derivation section 202 applies a derivation rule in which elements in the leftmost column are taken as a sequence of the horizontal axis, and elements of the other column are taken as a sequence of the vertical axis, and derives a bar graph indicating amounts of sales for the respective product names.

Although not illustrated in FIG. 5, the insight derivation section 202 can also derive a bar graph indicating unit prices of the respective product names in a similar manner. Thus, a plurality of insights may be derived from a single piece of verification data 212. In a case where a plurality of insights are derived from a single piece of verification data 212, the plurality of insights may be derived by applying different derivation rules, respectively.

In a case where a premise sentence is generated for the insight in graph form as described above, the premise sentence generation section 203 may apply a rule for generating a premise sentence for an insight in graph form. For example, the premise sentence generation section 203 may use, as a generation rule, a template “sequence name of vertical axis} is highest for {element of horizontal axis having highest value for vertical axis}”. Accordingly, the premise sentence generation section 203 can generate a premise sentence “amount of sales is highest for B”, as illustrated in FIG. 5. The premise sentence generation section 203 may of course generate a premise sentence using a machine learning model such as Chart-to-Text described above.

(Example 2 from Derivation of Insight to Generation of Premise Sentence)

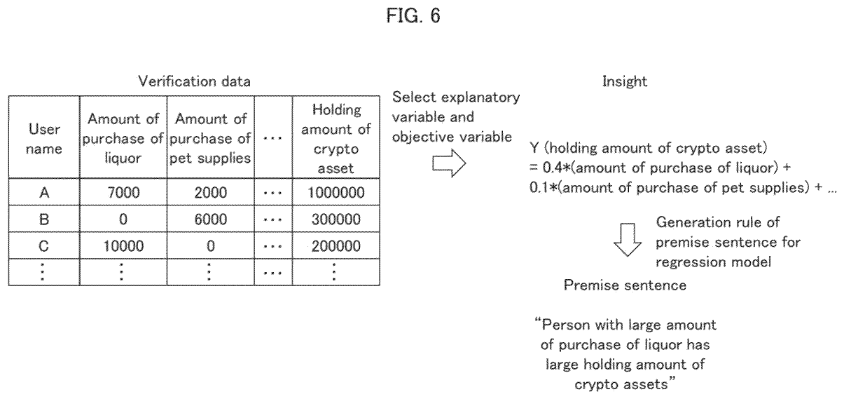

FIG. 6 is a diagram illustrating another example from derivation of an insight to generation of a premise sentence. The verification data 212 illustrated in FIG. 6 is data in table form indicating a relationship between user names, amounts of purchase in respective product categories (specifically, amounts of purchase of liquor, pet supplies, and the like), and holding amounts of crypto assets.

FIG. 6 illustrates an example in which the insight derivation section 202 derives, as an insight, a prediction expression for predicting an objective variable from an explanatory variable. In this case, the insight derivation section 202 selects, from among elements included in the verification data 212, an element as the explanatory variable and an element as the objective variable. The insight derivation section 202 can automatically carry out this selection if a criterion for selection is set in advance. Alternatively, the insight derivation section 202 may present, to a user, elements included in the verification data 212, and make the user select an element as the explanatory variable and an element as the objective variable.

In the example of FIG. 6, the holding amount of crypto asset is selected as an objective variable Y, and the amounts of purchase in the respective product categories are selected as explanatory variables. Thus, a prediction expression (specifically, a regression model) is derived in which Y (holding amount of crypto asset)=0.4*(amount of purchase of liquor)+0.1*(amount of purchase of pet supplies)+. . .

In a case where a premise sentence is generated from the regression model as described above, the premise sentence generation section 203 may apply a rule for generating a premise sentence for a regression model. For example, the premise sentence generation section 203 may use, as the generation rule, a template “person with large explanatory variable with highest correlation coefficient} has large {objective variable}”. Accordingly, the premise sentence generation section 203 can generate a premise sentence “person with large amount of purchase of liquor has large holding amount of crypto assets”, as illustrated in FIG. 6.

### (Method for Determining Degree of Entailment)

The following description will discuss a method for determining a degree of entailment by the verification section 204. The determination method only needs to be a method that can derive, from two pieces of text (i.e., a hypothetical sentence and a premise sentence), information indicating a degree of entailment between the two pieces of text. The verification section 204 of the present example embodiment determines a degree of entailment using the language understanding model 214.

The language understanding model 214 is a model that is constructed, upon receipt of input of a set of a hypothetical sentence and a premise sentence, to output an entailment score which is an index value indicating a degree to which the premise sentence entails the hypothetical sentence. The language understanding model 214 of this type can be constructed by learning whether or not a premise sentence entails a hypothetical sentence using, as training data, sets of premise sentences and hypothetical sentences whose entailment relationships are known.

The language understanding model 214 can be a combination of a pretrained language model that transforms a document into a vector along a context thereof and a language task model that classifies documents. In this case, each of a premise sentence and a hypothetical sentence is transformed into a vector by the pretrained language model, and from these vectors, an entailment score which indicates a degree to which the premise sentence entails the hypothetical sentence is calculated by the language task model.

The entailment score calculated using the language understanding model 214 indicates a degree to which the premise sentence input to the language understanding model 214 entails the hypothetical sentence also input to the language understanding model 214. A high entailment score indicates that the hypothetical sentence is likely to be correct, where the entailment score is supported by an insight or verification data 212 from which the premise sentence has been prepared.

Note that the method for determining a degree of entailment is not limited to the above-described method that utilizes the language understanding model 214 constructed using training data. For example, the verification section 204 may calculate a degree of similarity between a premise sentence and a hypothetical sentence which have been transformed into vectors by a pretrained language model, and use the calculated degree of similarity as an index value indicating a degree of entailment.

Any determination method can be applied to determination of a degree of entailment, provided that a relationship between a hypothetical sentence and a premise sentence can be defined. For example, an existing technique such as keyword matching or TF-inverse document frequency (IDF) may be used as a method for determining a degree of entailment.

In a method for determining a degree of entailment, it is possible to utilize auxiliary information of a hypothetical sentence. The auxiliary information of a hypothetical sentence is information which is related to the hypothetical sentence and which is not expressed in characters in the hypothetical sentence. Examples of the auxiliary information include time information at which a hypothetical sentence was generated or input. The auxiliary information may be information related to a subject that generates the hypothetical sentence. For example, in a case where a hypothetical sentence “xxx is watched mostly by males in their 40s” is verified when designing an advertising strategy in the retail industry, a subject that generates the hypothetical sentence is information related to a company that designs the advertising strategy. Examples of the information related to the company include information indicating attributes of the company such as products and services provided by the company, a sales form, a type of industry, and a scale.

In the method for determining a degree of entailment, a hypothetical sentence may be extended using those pieces of auxiliary information. For example, in a case where auxiliary information with respect to the hypothetical sentence “xxx is watched mostly by males in their 40s” is information indicating a company attribute “movie industry”, the verification section 204 may generate a hypothetical sentence “xxx is watched mostly by males in their 40s at movie theaters”. Alternatively, the verification section 204 may add vector data of the term “movie industry” to vector data of the generated hypothetical sentence. In this case also, as in the case of generating a hypothetical sentence as described above, verification can be carried out while taking into consideration auxiliary information.

The verification section 204 may cause the storage section 21 to directly store the calculated entailment score as it is as a verification result 215. For example, in a case where the number of entailment scores that exceed a threshold value set in advance among entailment scores which have been respectively calculated for a plurality of premise sentences is not less than a predetermined number, the verification section 204 may determine that a hypothetical sentence is correct. In a case where the number of entailment scores that exceed the threshold value is less than the predetermined number, the verification section 204 may determine that a hypothetical sentence is incorrect. In this case, the verification section 204 may store, as a verification result 215, whether the hypothetical sentence is correct or incorrect. Alternatively, for example, the verification section 204 may use, as a determination result of truth or falsity of a hypothetical sentence, a predetermined number of premise sentences having higher entailment scores among a plurality of premise sentences used in calculation of entailment scores. In this case, the verification section 204 may store, as a verification result 215, the predetermined number of premise sentences having higher entailment scores.

As described above, the verification section 204 may determine truth or falsity of a hypothetical sentence based on an entailment score which has been calculated using the language understanding model 214 constructed by learning whether or not a premise sentence entails a hypothetical sentence and which indicates a degree to which a premise sentence generated from an insight entails a hypothetical sentence to be verified. According to this configuration, it is possible to bring about an example advantage of obtaining a highly accurate determination result of truth or falsity, in addition to the example advantage brought about by the verification apparatus 1 in accordance with the first example embodiment.

### (Flow of Process)

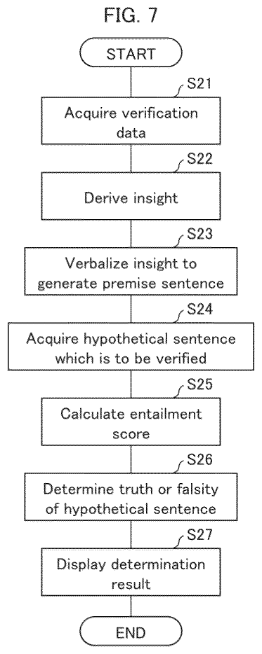

The following description will discuss a flow of a process (verification method) carried out by the verification apparatus 2, with reference to FIG. 7. FIG. 7 is a flowchart illustrating the flow of the process carried out by the verification apparatus 2.

In S21, the data acquisition section 201 acquires verification data and causes the storage section 21 to store the verification data as verification data 212. The data acquisition section 201 may acquire verification data input via the input section 22, or may acquire verification data from a storage location (that may be in the storage section 21 of the verification apparatus 2 or may be a storage apparatus outside the verification apparatus 2) designated by a user of the verification apparatus 2.

In S22, the insight derivation section 202 derives an insight from the verification data 212 which has been acquired and stored in S11. The insight derivation section 202 may cause the storage section 21 to store the derived insight. Subsequently, in S23, the premise sentence generation section 203 verbalizes the insight derived in S12 to generate a premise sentence, and causes the storage section 21 to store the generated premise sentence as a premise sentence 213.

In S24, the data acquisition section 201 acquires a hypothetical sentence which is to be verified, and causes the storage section 21 to store the hypothetical sentence as a hypothetical sentence 211. The data acquisition section 201 may acquire a hypothetical sentence that is input via the input section 22. Note that the data acquisition section 201 may acquire a hypothetical sentence when acquiring the verification data in S21.

In S25, the verification section 204 inputs the premise sentence 213 and the hypothetical sentence 211 into the language understanding model 214 to calculate an entailment score indicating a degree to which the premise sentence 213 entails the hypothetical sentence 211. Note that the entailment score is calculated for each of the plurality of premise sentences 213 stored in the storage section 21.

In S26, the verification section 204 determines truth or falsity of the hypothetical sentence 211 using the entailment scores calculated in S25. For example, the verification section 204 may use, as a determination result of truth or falsity, the entailment scores calculated in S25 as they are, or may use, as a determination result of truth or falsity, a predetermined number of higher entailment scores calculated in S25. Alternatively, for example, the verification section 204 may determine truth or falsity of the hypothetical sentence 211 based on whether or not the entailment scores calculated in S25 include an entailment score which exceeds a threshold value set in advance. Then, the verification section 204 causes the storage section 21 to store such a determination result as a verification result 215.

In S27, the verification result display section 205 causes the determination result in S26 to be displayed. At this time, the verification result display section 205 may display, together with the premise sentence which is the basis for determination of truth or falsity of the hypothesis, an insight or verification data 212 from which the premise sentence has been generated. For example, the verification result display section 205 may display, together with a premise sentence for which an entailment score exceeding the threshold value has been calculated, an insight or verification data 212 from which the premise sentence has been generated. Alternatively, for example, the verification result display section 205 may display a predetermined number of premise sentences having higher entailment scores in descending order of entailment score, and also display insights or verification data 212 from which the premise sentences have been generated.

### Variation

Each of the processes described in the above example embodiment may be carried out by an arbitrary execution subject, and the execution subject is not limited to the above-described example. That is, it is possible to construct a verification system that has functions similar to those of the verification apparatus 2 by a plurality of apparatuses that can communicate with each other. For example, by separately providing the blocks illustrated in FIG. 4 in a plurality of apparatuses, it is possible to construct a verification system having functions similar to those of the verification apparatus 2. For example, derivation of an insight, generation of a premise sentence, and verification of a hypothesis may be carried out by different apparatuses.

### Software Implementation Example

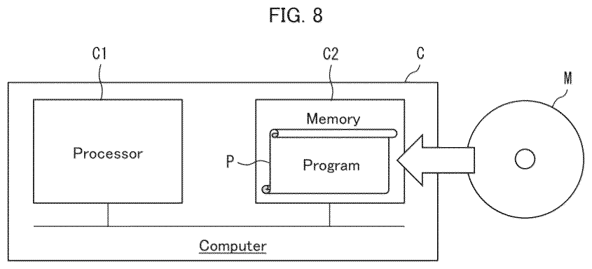

Some or all of the functions of the verification apparatus 2 may be implemented by hardware such as an integrated circuit (IC chip), or may be implemented by software. In the latter case, the verification apparatus 2 is realized by, for example, a computer that executes instructions of a program (verification program) that is software realizing the foregoing functions. FIG. 8 illustrates an example of such a computer (hereinafter, referred to as “computer C”). The computer C includes at least one processor C1 and at least one memory C2. The memory C2 stores a program P for causing the computer C to function as the verification apparatus 2. In the computer C, the processor C1 reads the program P from the memory C2 and executes the program P, so that the functions of the verification apparatus 2 are realized.

Examples of the processor C1 include a central processing unit (CPU), a graphic processing unit (GPU), a digital signal processor (DSP), a micro processing unit (MPU), a floating point number processing unit (FPU), a physics processing unit (PPU), a microcontroller, and a combination thereof. Examples of the memory C2 include a flash memory, a hard disk drive (HDD), a solid state drive (SSD), and a combination thereof.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a computer C-readable, non-transitory, and tangible storage medium M. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communication network, a broadcast wave, or the like. The computer C can obtain the program P also via such a transmission medium.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

Some or all of the foregoing example embodiments can also be described as below. Note, however, that the present invention is not limited to the following supplementary notes.

### Supplementary Note 1

A verification apparatus, including: a hypothetical sentence acquisition means for acquiring a hypothetical sentence which is to be verified; and a verification means for determining truth or falsity of the hypothetical sentence based on a degree to which the hypothetical sentence is entailed in a premise sentence that has been generated from a finding derived from verification data for use in verification of a hypothesis.

### Supplementary Note 2

The verification apparatus according to supplementary note 1, in which: the verification means determines truth or falsity of the hypothetical sentence based on an entailment score which has been calculated with use of a language understanding model constructed by learning whether or not a premise sentence entails a hypothetical sentence, the entailment score indicating a degree to which the premise sentence that has been generated from the finding entails the hypothetical sentence that has been acquired by the hypothetical sentence acquisition means.

### Supplementary Note 3

The verification apparatus according to supplementary note 1 or 2, further including: a verification data acquisition means for acquiring the verification data; a finding derivation means for deriving the finding from the verification data which has been acquired by the verification data acquisition means; and a premise sentence generation means for generating, from the finding derived by the finding derivation means, the premise sentence related to the finding.

### Supplementary Note 4

The verification apparatus according to supplementary note 3, in which: the verification data acquisition means acquires pieces of verification data in a plurality of data formats; and the finding derivation means derives, by applying derivation rules prepared for the respective plurality of data formats, findings from the pieces of verification data in the respective plurality of data formats.

### Supplementary Note 5

The verification apparatus according to supplementary note 3 or 4, in which: the finding derivation means derives findings in a plurality of data formats; and the premise sentence generation means generates, by applying generation rules prepared for the respective plurality of data formats of the findings, premise sentences from the findings in the respective plurality of data formats.

### Supplementary Note 6

A verification method, including: acquiring, by at least one processor, a hypothetical sentence which is to be verified; and determining, by the at least one processor, truth or falsity of the hypothetical sentence based on a degree to which the hypothetical sentence is entailed in a premise sentence that has been generated from a finding derived from verification data for use in verification of a hypothesis.

### Supplementary Note 7

A verification program for causing a computer to function as: a hypothetical sentence acquisition means for acquiring a hypothetical sentence which is to be verified; and a verification means for determining truth or falsity of the hypothetical sentence based on a degree to which the hypothetical sentence is entailed in a premise sentence that has been generated from a finding derived from verification data for use in verification of a hypothesis.

### Additional Remark 3

Furthermore, some of or all of the foregoing example embodiments can also be expressed as below. A verification apparatus, including at least one processor, the at least one processor carrying out: a hypothetical sentence acquisition process for acquiring a hypothetical sentence which is to be verified; and a verification process for determining truth or falsity of the hypothetical sentence based on a degree to which the hypothetical sentence is entailed in a premise sentence that has been generated from a finding derived from verification data for use in verification of a hypothesis.

Note that the verification apparatus can further include a memory. The memory can store a program for causing the at least one processor to carry out the hypothetical sentence acquisition process and the verification process. The program can be stored in a computer-readable non-transitory tangible storage medium.

### REFERENCE SIGNS LIST

1, 2: Verification apparatus
11: Hypothetical sentence acquisition section
12, 204: Verification section
20: Control section
21: Storage section
22: Input section
23: Output section
201: Data acquisition section
202: Insight derivation section
203: Premise sentence generation section
205: Verification result display section
211: Hypothetical sentence
212: Verification data
213: Premise sentence
214: Language understanding model
215: Verification result
C1: Processor
C2: Memory

What is claimed is:

1. A verification apparatus, comprising at least one processor, the at least one processor carrying out:
a hypothetical sentence acquisition process of acquiring a hypothetical sentence which is to be verified; and
a verification process of determining truth or falsity of the hypothetical sentence based on a degree to which the hypothetical sentence is entailed in a premise sentence that has been generated from a finding derived from verification data for use in verification of a hypothesis.

2. The verification apparatus according to claim 1, wherein:
in the verification process, the at least one processor determines truth or falsity of the hypothetical sentence based on an entailment score which has been calculated with use of a language understanding model constructed by learning whether or not a premise sentence entails a hypothetical sentence, the entailment score indicating a degree to which the premise sentence that has been generated from the finding entails the hypothetical sentence that has been acquired in the hypothetical sentence acquisition process.

3. The verification apparatus according to claim 1, wherein:
the at least one processor further carries out a verification data acquisition process of acquiring the verification data;
the at least one processor further carries out a finding derivation process of deriving the finding from the verification data which has been acquired in the verification data acquisition process; and
the at least one processor further carries out a premise sentence generation process of generating, from the finding derived in the finding derivation process, the premise sentence related to the finding.

4. The verification apparatus according to claim 3, wherein:
in the verification data acquisition process, the at least one processor acquires pieces of verification data in a plurality of data formats; and
in the finding derivation process, the at least one processor derives, by applying derivation rules prepared for the respective plurality of data formats, findings from the pieces of verification data in the respective plurality of data formats.

5. The verification apparatus according to claim 3, wherein:
in the finding derivation process, the at least one processor derives findings in a plurality of data formats; and
in the premise sentence generation process, the at least one processor generates, by applying generation rules prepared for the respective plurality of data formats of the findings, premise sentences from the findings in the respective plurality of data formats.

6. A verification method, comprising:
acquiring, by at least one processor, a hypothetical sentence which is to be verified; and
determining, by the at least one processor, truth or falsity of the hypothetical sentence based on a degree to which the hypothetical sentence is entailed in a premise sentence that has been generated from a finding derived from verification data for use in verification of a hypothesis.

7. A non-transitory storage medium storing a verification program for causing a computer to carry out:
a hypothetical sentence acquisition process of acquiring a hypothetical sentence which is to be verified; and
a verification process of determining truth or falsity of the hypothetical sentence based on a degree to which the hypothetical sentence is entailed in a premise sentence that has been generated from a finding derived from verification data for use in verification of a hypothesis.
